(19) United States
(12) Patent Application Publication
(10) Pub. No.: US 2010/0113070 A1
(43) Pub. Date: May 6, 2010

(54) METHOD AND SYSTEM FOR MANAGING PAGING IN WIRELESS COMMUNICATION NETWORK

(75) Inventors: Anshuman NIGAM, Bangalore (IN); Baowei JI, Plano, TX (US); Hyun-Jeong KANG, Seoul (KR); Jae-Hee CHO, Seoul (KR); Taori RAKESH, Suwon-si (KR)

Correspondence Address: Jefferson IP Law, LLP, 1130 Connecticut Ave., NW, Suite 420, Washington, DC, 20036, US

(73) Assignee: Samsung Electronics Co. Ltd., Suwon-si (KR)

(21) Appl. No.: 12/609,879

(22) Filed: Oct. 30, 2009

(30) Foreign Application Priority Data
Oct. 31, 2008 (IN) 2662/CHE/2008PS
Oct. 26, 2009 (IN) 2662/CHE/2008CS

(51) Int. Cl. H04W 68/00

(52) U.S. Cl. 455/458

(57) ABSTRACT

A method and system for managing paging for a communication device in a paging area is provided. The method at a second base station includes receiving information associated with a movement of the communication device from a first cell region associated with a first base station to a second cell region associated with the second base station in the paging area. The first base station and the second base station are of different cell types. The method then informs a paging controller about the movement of the communication device along with information associated with the communication device when at least one of the first base station and the second base station is a femtocell. The paging controller on receiving a page for the communication device identifies presence of the communication device in a femtocell and manages paging of the communication device in one or more femtocells in the paging area.

### PRIORITY

This application claims the benefit under 35 U.S.C. §119(a) of an Indian provisional patent application filed on Oct. 31, 2008 in the Indian Intellectual Property Office and assigned Serial No. 2662/CHE/2008 (PS), and an Indian Non-provisional patent application filed on Oct. 26, 2009 in the Indian Intellectual Property Office and assigned Serial No. 2662/CHE/2008 (CS), the entire disclosure of which is hereby incorporated by reference

### BACKGROUND OF THE INVENTION

1. Field of the Invention

The present invention relates to managing communication in communication network. More particularly the present invention relates to managing paging in a paging area in a wireless communication network.

2. Background of the Invention

Over a period of time, technology associated with communication network has evolved significantly. The communication network allows a plurality of communication devices to communicate with each other. The communication network can be a wire lined communication network or a wireless communication network. An example of wire lined communication network is public switched telephone network (PSTN). Examples of wireless communication network includes, but are not limited to, Global system for mobile communications (GSM) network, Code Division Multiple Access (CDMA) network, communication network associated with IEEE 802.16 group of wireless standards. An example of communication network associated with IEEE 802.16 group of wireless standards is WiMAX standards.

Examples of communication devices include but are not limited to mobile phones, personal digital assistance (PDA), laptops and computers. A communication device for example a mobile device can communicate with other mobile device through a wireless communication network within a wireless communication range.

The wireless communication range in the wireless communication network is divided into a plurality of regions called radio cells. Each radio cell has a base station. A base station is a radio transmitter and receiver used for transmitting and receiving voice and data signal to and from communication devices in a radio cell. Hence, one communication device (mobile station) can communicate with the other communication devices (mobile station) in the wireless communication network through one or more base stations. The base stations can be classified under different categories.

For example, the base stations are classified based on the coverage area they cover for communication. For example a femtocell that is a low power base station is typically intended for home or Small Office Home Office (SOHO) usage. The macro base station is a high power base station and is commonly used to cover a larger communication area. The MS in a communication network can be either in idle mode or in active mode. The active mode is the mode in which the MS is communicating with the base station. The idle mode is the mode in which the MS is not involved in active communication with the base station (BS) and thus sleeps for a specific period of time. The MS in idle mode wakes up periodically to check if there is any data or call for it and to check for any updates in system information broadcasted by the BS.

The idle mode is designed to reduce power consumption in MSs. The MSs in idle mode are tracked by the communication network using paging and location update procedures. The paging may be used to determine location of a particular MS in the communication network or to establish a call involving the MS. However, in idle mode MS does not maintain a continuous active connection with the communication network. Instead a paging cycle is established during which the MS will periodically wake up at pre-determined paging occasions to listen for the paging activity in the communication network.

For efficient paging, the communication network is divided in to different paging areas. A paging area is defined as a collection of BSs where a MS is paged. Therefore when a MS crosses it's paging area it informs the communication network about it by a procedure known as location update procedure. The number of BSs constituting a paging area is a tradeoff involving frequency of location updates and paging load in the system for paging a MS. Larger the paging area, higher is the paging load as more number of BSs will page the MS. The smaller the paging area the higher the number of location updates, as a moving MS will cross more number of paging areas in a given time.

Thus when a first MS located in a first paging area is paged by a second MS then in one method, all base stations located in the first paging area pages for the first mobile station. Therefore the entire base stations, for example femtocell, picocell, micro cell and macro cell base stations under the paging area pages for the first MS. Thereafter when the MS location is identified and the communication link is established between the first MS and the second MS. However, there might be a case that the first MS is under a femtocell area and usually remains in the femtocell region for a longer period of time as the femtocell is associated with home region or office region. Then resources of the microcell and/or macrocell are unnecessarily wasted due to the load of paging the MS which is under the femtocell.

Hence an efficient paging scheme is required when a MS in a paging area is under a femtocell region.

### SUMMARY OF THE INVENTION

In an embodiment, a method for managing paging for a communication device in a paging area is provided. The method is performed at a second base station. The method includes receiving information associated with a movement of the communication device from a first cell region associated with a first base station to a second cell region associated with the second base station in the paging area. The first base station and the second base station are of different cell types. The method also includes informing a paging controller about the movement of the communication device along with information associated with the communication device when at least one of the first base station and the second base station is a femtocell, wherein the information associated with the communication device is at least one of a Mobile Station Identity (MSID), a Paging area Identity (PGID) and a Base Station Identity (BSID).

In another embodiment, a method for managing paging for a communication device in a paging area is provided. The method is performed at a communication device. The method includes identifying movement of the communication device from a first cell region associated with a first base station to a second cell region associated with a second base station in the paging area. In the method the first base station and the second base station are of different cell types. The method then includes sending information associated with the movement of the communication device from the first cell region to the second cell region to the second base station when at least one of the first base station and the second base station is a femtocell.

In yet another embodiment, a method for managing paging for a communication device in a paging area is provided. The method is performed at a paging controller. The method includes receiving informing about a movement of the communication device from a first cell region associated with a first base station to a second cell region associated with a second base station along with information associated with the communication device when at least one of the first base station and the second base station is a femtocell. In the method the first base station and the second base station are of different cell types. Further the information associated with the communication device is at least one of a Mobile Station Identity (MSID), a Paging area Identity (PGID) and a Base Station Identity (BSID). The method also includes maintaining presence information of the communication device along with the information of the communication device in a database when the communication device is under a femtocell and when at least one of a first cell is a femtocell and a second cell is a femtocell.

In still another embodiment, a second base station is provided. The base station includes a receiver and a transmitter. The receiver is capable of receiving information associated with a movement of a communication device from a first cell region associated with a first base station to a second cell region associated with the second base station in a paging area. The first base station and the second base station are of different cell types. The transmitter is capable of sending information to a paging controller about the movement of the communication device along with information associated with the communication device when at least one of the first base station and the second base station is a femtocell. The information associated with the communication device is at least one of a Mobile Station Identity (MSID), a Paging area Identity (PGID) and a Base Station Identity (BSID).

In still another embodiment, a communication device is provided. The communication device includes a processor and a transceiver. The processor identifies movement of the communication device from a first cell region associated with a first base station to a second cell region associated with a second base station in a paging area. In an embodiment, the first base station and the second base station are of different cell types. The transceiver in the communication device then sends information associated with the movement of the communication device from the first cell region to the second cell region to the second base station when at least one of the first base station and the second base station is a femtocell.

In still another embodiment, a paging controller is provided. The paging controller includes a transceiver and a memory. The transceiver in the paging controller receives information about a movement of a communication device from a first cell region associated with a first base station to a second cell region associated with a second base station when at least one of the first base station and the second base station is a femtocell along with information associated with the communication device. The first base station and the second base station are of different cell types. Further the information associated with the communication device is at least one of a Mobile Station Identity (MSID), a Paging area Identity (PGID) and a Base Station Identity (BSID). The memory in the paging controller maintains the presence information of the communication device along with the information of the communication device in a database when the communication device is under a femtocell and when at least one of a first cell is a femtocell and a second cell is a femtocell.

The features and advantages of the present invention will become more apparent from the ensuing detailed description of the invention taken in conjunction with the accompanying drawings.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE FIGURES

For a more complete understanding of the present disclosure and its advantages, reference is now made to the following description taken in conjunction with the accompanying drawings, in which like reference numerals represent like parts:

FIG. 1 illustrates an exemplary environment, where various embodiments of the present invention can be practiced;

FIG. 2 illustrates a base station, in accordance with one embodiment of the present invention;

FIG. 3 illustrates a communication device, in accordance with one embodiment of the present invention;

FIG. 4 illustrates a paging controller, in accordance with one embodiment of the present invention; and

FIG. 5 illustrates a flow chart depicting a method for managing paging in a wireless communication network, in accordance with one embodiment of the present invention;

FIG. 6 illustrates a flow chart depicting a method for managing paging in a wireless communication network, in accordance with another embodiment of the present invention;

FIG. 7 illustrates a flow chart depicting a method for managing paging in a wireless communication network, in accordance with yet another embodiment of the present invention; and

FIG. 8 illustrates a flow chart depicting a method for managing paging in a wireless communication network based on IEEE 802.16 standard, in accordance with an embodiment of the present invention.

Persons skilled in the art will appreciate that elements in the figure is illustrated for simplicity and clarity and may have not been drawn to scale. For example, the dimensions of some of the elements in the figure may be exaggerated relative to other elements to help to improve understanding of various embodiments of the present disclosure.

### DETAILED DESCRIPTION OF EXEMPLARY EMBODIMENTS

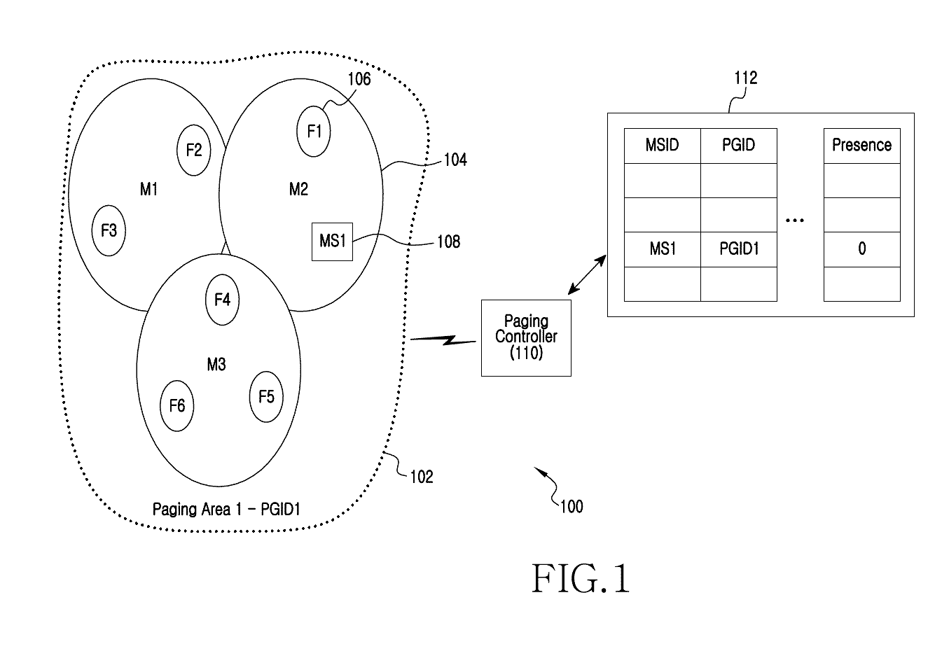

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are no where intended to represent a chronological order, as and where stated otherwise. A set is defined as a non-empty set including at least one element.

FIG. 1 illustrates an exemplary environment 100, where various embodiments of the present invention can be practiced. The environment 100 includes a paging area, a plurality of base stations, a plurality of communication devices and a paging controller. For example, the environment 100 includes a paging area 102, a plurality of base stations, for example, a plurality of Macrocell base stations M1, M2 (104), and M3, and a plurality of femtocell base stations F1 (106), F2, F3, F4, F5, and F6 and Mobile station MS1 (108). The plurality of base stations in the paging area 102 is connected with a paging controller 110. The paging controller is associated with a database 112 to store information about the MS and BS.

However, only three Macrocell, six femtocell and one MS are shown in the environment 100, it will be apparent to the person ordinary skilled in the art that the environment 100 includes more number of BS and more number of mobile stations in the paging area. For the purpose of this description and for the sake of clarity the femtocell base station will also be referred as femtocell and the macrocell base station will also be referred as macrocell. Further, the terms communication device and mobile station will also be used interchangeably.

The plurality of base stations (M1, M2, M3, F1, F2, F3, F4, F5, and F6) and the paging controller 110 enable communication between a plurality of communication devices (Mobile Stations) in a wireless communication range. Hence, when a second Mobile Station (MS) (not shown in figure) want to communicate with a first MS, for example the MS 108 in the paging area 102 then the paging controller 110 sends an indication to one or more base stations in the paging area to page for the MS 108. In an embodiment, the paging controller 110 is made aware of the presence of the MS 108 under a femtocell or under a macrocell. The presence information is maintained in the database 112.

This enables the paging controller 110 to efficiently page the MS 108 as per the presence of the MS 108. Thus, when the MS 108 is present under a femtocell region (F1, F2, F3, F4, F5, and F6) none of the macrocells (M1, M2, and M3) in the paging area should page the MS 108. However, when the MS 108 is under a macro cell in the same paging area, the regular paging scheme follows as in macro only deployment. In this situation, the femtocells in the paging area should not page the MS.

This can be achieved by informing a femtocell or a macrocell in the paging area about the movement of the MS 108 in a femtocell region. In an embodiment, when the MS 108 is entering in a femtocell region the associated femtocell can be informed about the movement of the MS. Further, the femtocell can inform the paging controller 110 in the network about the movement of the MS 108. For example, when the MS 108 enters the femtocell region associated with femtocell 106 (F1) then the MS 108 can inform the femtocell 106 about its presence in the femtocell 106. Thereafter, the femtocell 106 will inform the paging controller 110.

In another embodiment, when the MS is exiting the femtocell, the MS can inform the macrocell BS about it. The macro BS can then inform the paging controller in the network about the movement of the MS. For example, the MS 108 can inform the Macro BS (M2) about its movement then the Macro base station informs the paging controller 110 about the movement of the MS 108.

In an embodiment, the MS informs the femtocell about its entering or exiting the femtocell and thereby femtocell informs the macro BS which in turn informs the paging controller about the movement. Hence, as a result the paging controller is made aware of the MS presence in the femtocell or the macro BS.

In an embodiment, the paging controller keeps a record of all the MSs that are served by femtocell in idle mode. Thus when the page for the MS 108 arrives at the paging controller 110, it checks from a database 112 stored in the memory if the MS is under a femtocell or not. Thereafter, if the MS is under a femtocell then the MS 108 is paged under one or more femtocell(s) in the paging area. In an embodiment, the paging controller pages the MS only in a specific femtocell if the paging controller is aware of the femtocell Base Station Identity (BSID) under which the MS 108 is present.

In another embodiment, the MS is paged in all the femtocells in the paging area if femto BSID is not known. In another embodiment, the MS is paged in the entire paging area 102. In another embodiment, the MS is paged using existing paging methods if the MS is not under a femtocell region. When the page message arrives at the femtocell BS, it checks with the list of MSs that are in idle mode and are currently served by it. Further, the BS sends the page if the paged MS Identification number (ID) matches to an entry in the list, or else the BS does not send the page.

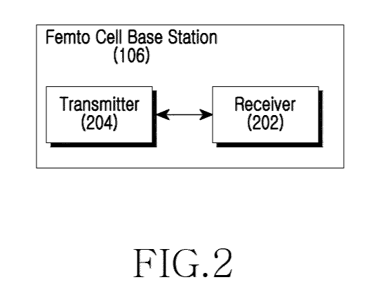

FIG. 2 illustrates a base station 106, in accordance with one embodiment of the present invention. To explain the base station, references will be made to FIG. 1. However, it will be apparent to a person ordinarily skilled in the art that the present embodiment can be explained with the help of any other suitable embodiment of the present invention. The Base Station (BS) 106 includes a receiver 202 and a transmitter 204.

The receiver 202 is capable of receiving information associated with a movement of a communication device from a first cell region associated with a first base station to a second cell region associated with the second base station in a paging area. For example, the receiver 202 receives information about the movement of the MS 108. Hence, when the MS 108 moves from the macrocell region 104 to the femtocell region 106 the receiver 202 of the base station 106 will receive the information. The first base station and the second base station are of different cell types. For example, the first base station is a macrocell 104 and the second base station is femtocell 106.

The transmitter 204 in the base station 106 is capable of sending information to a paging controller 110 about the movement of the communication device, for example the MS 108, along with information associated with the communication device when at least one of the first base station and the second base station is a femtocell. The information associated with the communication device is at least one of a Mobile Station Identity (MSID), a Paging area Identity (PGID) and a Base Station Identity (BSID).

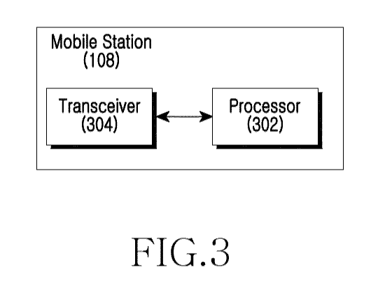

FIG. 3 illustrates a communication device 108, in accordance with one embodiment of the present invention. To explain the communication device 108, references will be made to FIG. 1. However, it will be apparent to a person ordinarily skilled in the art that the present embodiment can be explained with the help of any other suitable embodiment of the present invention. The communication device 108 includes a processor 302 and a transceiver 304.

The processor 302 identifies movement of the communication device 108 from a first cell region associated with a first base station to a second cell region associated with a second base station in a paging area. In an embodiment, the first base station and the second base station are of different cell types. For example, the processor 302 in the MS 108 will identify the movement when the MS 108 moves from a region associated with a macrocell, for example the macrocell 104, to the region associated with a femtocell, for example the femtocell 106.

The transceiver 304 in the communication device 108 then sends information associated with the movement of the communication device 108 from the first cell region (macrocell 104) to the second cell region to the second base station 106 (femtocell 106) when at least one of the first base station and the second base station is a femtocell. In an embodiment, the MS 108 will send the movement information to a femtocell when the MS 108 enters in the femtocell region. In another embodiment, the MS 108 will send the movement information to a macrocell when the MS 108 exits from the femtocell region.

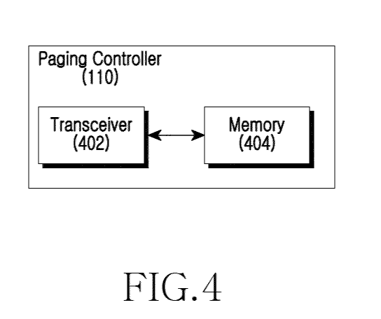

FIG. 4 illustrates a paging controller 110, in accordance with one embodiment of the present invention. To explain the paging controller, references will be made to FIG. 1. However, it will be apparent to a person ordinarily skilled in the art that the present embodiment can be explained with the help of any other suitable embodiment of the present invention. The paging controller includes a transceiver 402 and a memory 404.

The transceiver 402 in the paging controller receives information about a movement of a communication device from a first cell region associated with a first base station to a second cell region associated with a second base station when at least one of the first base station and the second base station is a femtocell along with information associated with the communication device. The first base station and the second base station are of different cell types. For example, when the MS 108 moves from the macrocell 104 to the femtocell 106 the transceiver 402 of the paging controller receives information about the movement. In an embodiment, the information associated with the communication device is at least one of a Mobile Station Identity (MSID), a Paging area Identity (PGID) and a Base Station Identity (BSID).

Further, the memory 404 in the paging controller 110 maintains presence information of the communication device along with the information of the communication device in a database when the communication device is under a femtocell and when at least one of a first cell is a femtocell and a second cell is a femtocell. In an embodiment, the memory is externally associated with the paging controller 110. In another embodiment, the memory is internal to the paging controller. Hence, the memory contains the database 112 that manages information about the presence of communication devices under a femtocell (as shown in FIG. 1).

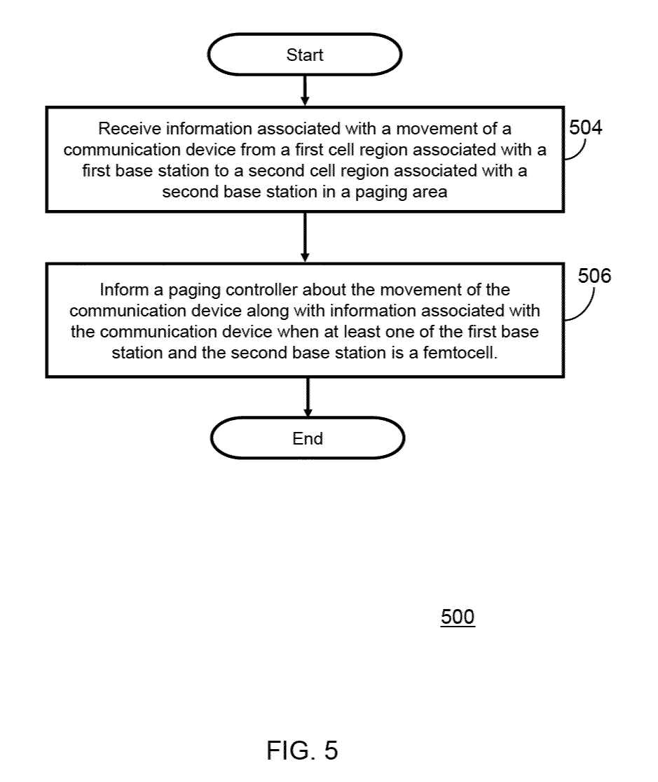

FIG. 5 illustrates a flow chart depicting a method for managing paging in a wireless communication network, in accordance with one embodiment of the present invention. To explain the method 500, references will be made to FIG. 1. However, it will be apparent to a person ordinarily skilled in the art that the present embodiment can be explained with the help of any other suitable embodiment of the present invention. The method 500 can also include more or fewer number of steps as depicted in FIG. 5. Further, the order of the steps may also vary. In an embodiment, the method is performed by a second base station.

At step 502 the method is initiated. In an embodiment, the method is performed at a second base station. At step 504, the method at the base station 106, receives information associated with a movement of a communication device, for example the MS 108, from a first cell region associated with a first base station (the macrocell 104) to a second cell region associated with the second base station (the femtocell 106) in a paging area 102. In an embodiment, the first base station and the second base station are of different cell types.

In an embodiment, the first base station is at least one of a macrocell, microcell, and a picocell and the second base station is a femtocell. In another embodiment, the first base station is a femtocell and the second base station is at least one of a macrocell, micro cell, and a picocell. For example the first base station is macrocell and the second base station is a femtocell. Further, the information about the movement of the communication device includes the information about the communication device that is entering in a femtocell region or exiting from a femtocell region.

In an embodiment, the information associated with the movement of the communication device is received in an Advance Air Interface Ranging-Request (AAI_RNG-REQ) message from the MS 108. In an embodiment, the information associated with the movement of the communication device is received in a ranging purpose indication field of the information AAI_RNG-REQ message. Hence, the movement of the MS 108, for example exiting from a region associated with a femtocell or entering in a region associated with a femtocell is identified based on values of one or more bits in the ranging purpose indication field of the AAI_RNG-REQ message.

At step 506, the method 500 informs a paging controller 110 about the movement of the communication device (MS 108) along with information associated with the communication device when either the first base station or the second base station is a femtocell. In an embodiment, the information associated with the communication device is at least one of a Mobile Station Identity (MSID), a Paging area Identity (PGID) and a Base Station Identity (BSID).

In an embodiment, the paging controller is informed about the movement of the communication device using a Location Update (LU)-Request (REQ) message. For example the Location Update (LU)-Request (REQ) message is sent to the paging controller 110 indicating at least one of the movement of the communication device (MS 108) from a femtocell (the femtocell 106) to at least one of a microcell, a macrocell, and a picocell (the Macrocell 104). Similarly the Location Update (LU)-Request (REQ) message is sent to the paging controller 110 indicating at least one of the movements of the communication device (MS 108) from at least one of a microcell, a macrocell, and a picocell (the Macrocell 104) to a femtocell (the femtocell 106). In an embodiment, the method is performed according to the IEEE 802.16e standard, a 3rd Generation Partnership Project (3GPP) standard, or the IEEE802.16m standard. At step 508 the method is terminated.

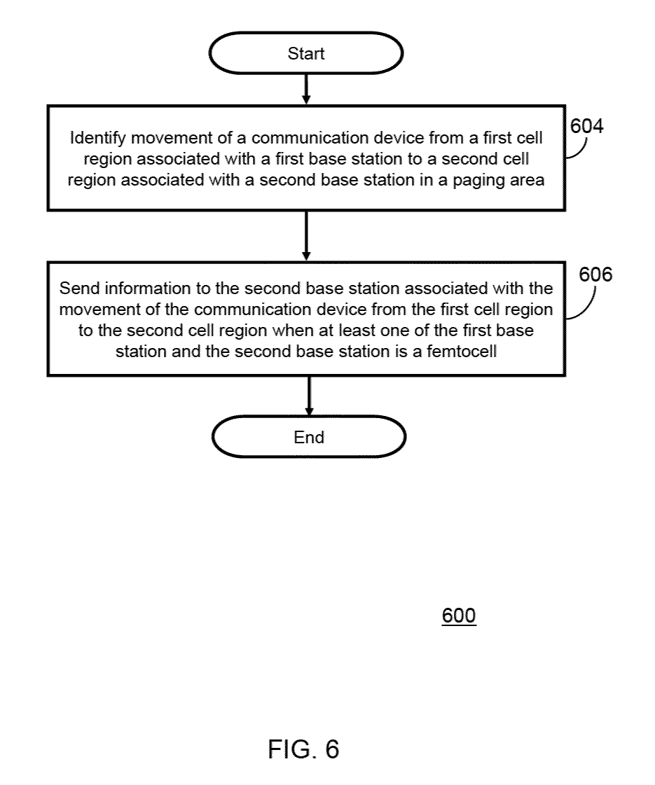

FIG. 6 illustrates a flow chart depicting a method for managing paging in a wireless communication network, in accordance with another embodiment of the present invention. To explain the method 600, references will be made to FIG. 1. However, it will be apparent to a person ordinarily skilled in the art that the present embodiment can be explained with the help of any other suitable embodiment of the present invention. The method 600 can also include more or fewer number of steps as depicted in FIG. 6. Further, the order of the steps may also vary. In an embodiment, the method is performed by the communication device.

At step 602 the method is initiated. In an embodiment, the method is performed at a communication device (MS 108). At step 604, the method 600 identifies movement of the communication device (the MS 108) from a first cell region associated with a first base station (the macrocell 104) to a second cell region associated with a second base station (the femtocell 106) in a paging area (the paging area 102). In an embodiment, the first base station and the second base station are of different cell types. In an embodiment, the first base station is at least one of a macrocell, microcell, and a picocell and the second base station is a femtocell. In another embodiment, the first base station is a femtocell and the second base station is at least one of a macrocell, microcell, and a picocell.

At step 606, the method 600 send information associated with the movement of the communication device from the first cell region to the second cell region to the second base station when at least one of the first base station and the second base station is a femtocell. In other words, when the MS 108 enters a femtocell region the method informs the movement of the MS 108 to the femtocell base station and when the MS 108 exits a femtocell region to a macrocell or microcell or picocell region the method informs the movement of the MS 108 to the macrocell or microcell or picocell region. In an embodiment, the method sends information in an Advance Air Interface Ranging-Request (AAI_RNG-REQ) message. In an embodiment, the information associated with the movement of the communication device is sent in a ranging purpose indication field of the AAI_RNG-REQ message. At step 608 the method is terminated.

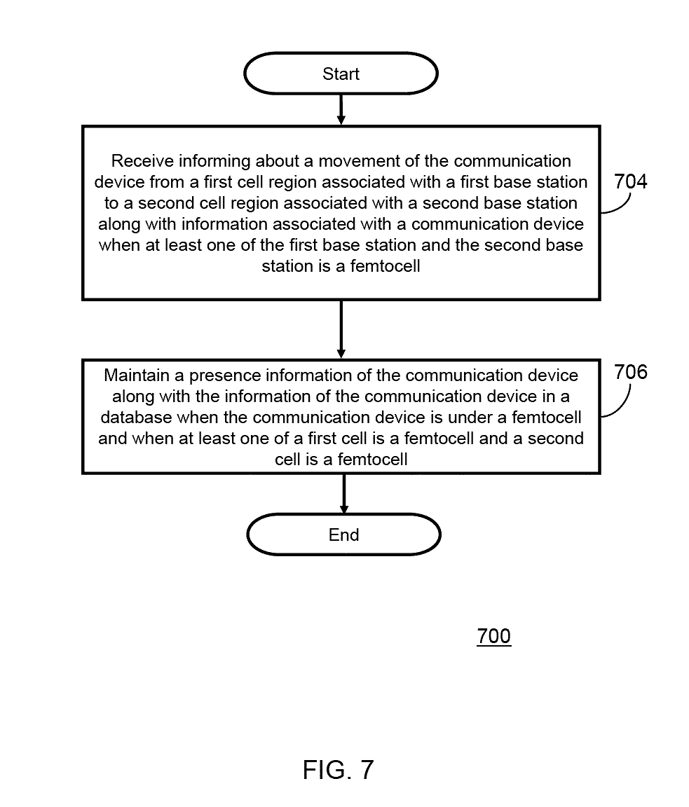

FIG. 7 illustrates a flow chart depicting a method for managing paging in a wireless communication network, in accordance with one embodiment of the present invention. To explain the method 700, references will be made to FIG. 1. However, it will be apparent to a person ordinarily skilled in the art that the present embodiment can be explained with the help of any other suitable embodiment of the present invention. The method 700 can also include more or fewer number of steps as depicted in FIG. 7. Further, the order of the steps may also vary. In an embodiment, the method is performed by a paging controller.

At step 702 the method is initiated. In an embodiment, the method is performed at a paging controller 110. At step 704 the method 700 receives information about a movement of the communication device from a first cell region associated with a first base station to a second cell region associated with a second base station along with information associated with the communication device when at least one of the first base station and the second base station is a femtocell. For example the paging controller 110 receives information about the movement of the MS 108 when the MS 108 enters a femtocell region or exits from a femtocell region.

In an embodiment, the first base station and the second base station are of different cell types. In an embodiment, the information associated with the communication device is at least one of a Mobile Station Identity (MSID), a Paging area Identity (PGID) and a Base Station Identity (BSID). At step 706, the method maintains presence information of the communication device along with the information of the communication device in a database when the communication device is under a femtocell and when at least one of a first cell is a femtocell and a second cell is a femtocell. In an embodiment, the presence information is the information about the presence of communication device (the MS 108) under a femtocell. In an embodiment, the information is maintained in the memory 404. In an example, the presence information and the information associated with the communication device is maintained in a database (the database 112) in the memory 404 (as shown in FIG. 1).

Hence, the paging controller 110 manages paging of the MS under the femtocell based on the database maintained. In an embodiment, when the paging controller 110 receives a page for the communication device (the MS 108) from a second communication device for establishing a communication channel the paging controller identifies a presence of the MS 108 in a femtocell based on the presence information of the MS 108 maintained in the database. For example, the paging controller scans the list of information associated with plurality of MS in the database and identifies the presence information of the MS 108. Then the method at paging controller pages the one or more femtocell in the paging area if the MS 108 is present in a femtocell. At step 708 the method is terminated.

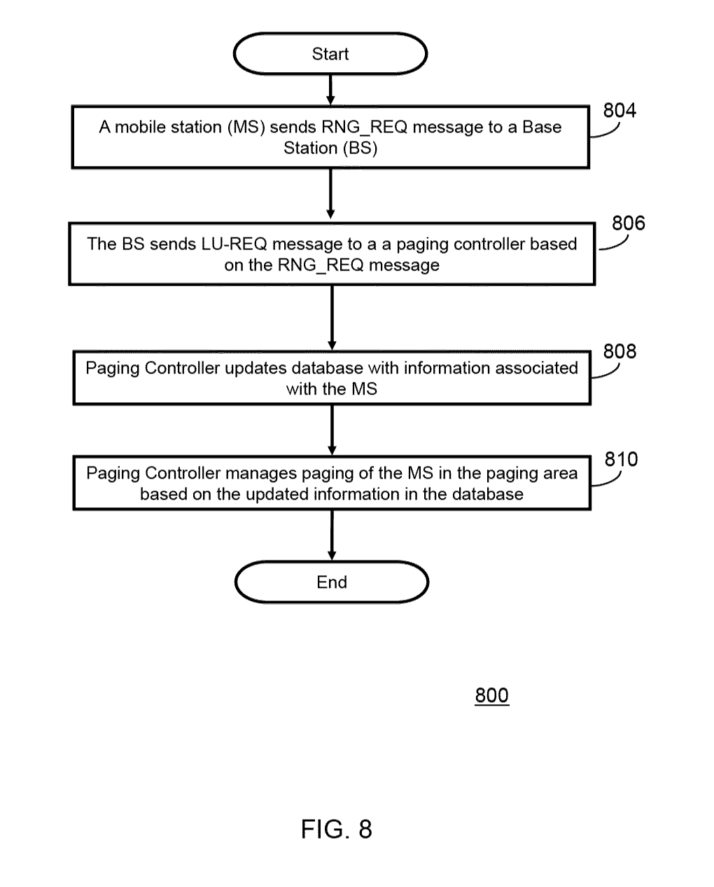

FIG. 8 illustrates a flow chart depicting a method for managing paging in a wireless communication network based on IEEE 802.16 standard, in accordance with an embodiment of the present invention. To explain the method 800, references will be made to FIG. 1. However, it will be apparent to a person ordinarily skilled in the art that the present embodiment can be explained with the help of any other suitable embodiment of the present invention. The method 800 can also include more or fewer number of steps as depicted in FIG. 8. Further, the order of the steps may also vary.

The method 800 is initiated at step 802. At step 804, a MS (for example the MS 108) entering in or exiting from a femtocell can send an indication to a base station by utilizing the Location Update (LU) procedure in the IEEE802.16m system. In the LU procedure the MS 108 after synchronizing to a target BS, performs initial ranging by sending a Ranging-Request message (RNG-REQ message) with ranging purpose indication set to idle mode location update. Thus, in order to indicate an entry or exit to the femtocell within the same paging area, the MS can use a reserve value of the ranging purpose indication fields besides setting an appropriate indication for idle mode location update using setting of bit 3 of ranging purpose indication. For example, the ranging purpose indication bit 5 can be set to 1. This ranging purpose indication can be termed as “MS Femto presence indicator”.

In an example, the ranging purpose indication field can be used as mentioned in the following table. Please note that the following table is solely for the purpose of the description and no where limits the scope of the invention to the following the example. Hence a person ordinary skilled in the art can use any combination of bits and any value to notify the information.

| Name | Usage |
|---|---|
| MS_Random | |
| MAC Version | |
| Ranging Purpose Indication | Bit0 - if set to 1 indicates unprepared |
| | HO |
| | Bit 1 - if set to 1 indicates network entry |
| | from idle mode |
| | Bit 2 - if set to 1 indicates prepared HO |
| | Bit 3 - if set to 1 indicates normal idle |
| | mode location update |
| | Bit 4 - if set to 1 indicates emergency call |
| | setup |
| | Bit 5 - if set to 1 indicates that the MS |
| | has entered a femtocell, if set to 0 |
| | indicates that MS has exited from a |
| | femtocell. This is termed as MS Femto |
| | presence indicator. |
| | Bit 6 - if set to 1 indicates that MS has |
| | exited from a femtocell. This is termed |
| | as MS Femto absence indicator. |
| | Bit 7 - reserved |
| Serving BSID | |
| Previous STID | |
| Paging Controller ID | |
| Temporary ID | |
| Paging Cycle Change | |
| Power Down Indicator | |
| CMAC_KEY_COUNT | |
| CMAC Tuple | |

In first embodiment, bit 5 of the ranging purpose indication field is used to indicate entry to a femtocell and exit from a femtocell. For example, bit 5 can be set as ‘1’ to indicate that the MS has entered a femtocell and bit 5 can be set as ‘0’ to indicate that the MS has exited from a femtocell.

In second embodiment, bit 5 is used to indicate entry to a femtocell and bit 6 is used to indicate exit from a femtocell. For example, bit 5 can be set to ‘1’ to indicate that the MS has entered a femtocell and bit 6 can be set to ‘1’ to indicate that the MS has exited from the femtocell. In this embodiment when the bit 5 is set to ‘1’ and the bit 6 is set to ‘1’ the BS shall treat this as invalid and will ignore the Ranging-Request message. Similarly when the bit 5 is set to ‘0’ and the bit 6 is set to ‘0 ’ the BS shall also treat this condition as invalid and will ignore the Ranging-Request message.

The first embodiment and the second embodiment are solely for the purpose of clarity and no where limits the scope of the invention. Hence a person ordinarily skilled in the art can use any other bit or a combination of bits of the ranging purpose indication field to indicate entry or exit of a mobile station to/from the femto cell region. However, for the purpose of this description the first embodiment will be primarily used for explanation.

On receipt of the RNG-REQ message with ranging purpose indication set to MS Femto presence indicator, the BS at step 806 sends a Location Update (LU)-Request (REQ), for example LU-REQ, to a gateway, for example ASN-GW, which in turn forwards it to a Paging Controller. The LU-REQ is also enhanced to contain an additional field which is termed as the MS Femto presence indicator. For example, the MS Femto presence indicator field can be one bit information.

In an example, the LU request message can used as mentioned in the following table. Please note that the following table is solely for the purpose of the description and no where limits the scope of the invention to the following the example. Hence a person ordinary skilled in the art can use any combination of bits and any value to notify the information.

| Name | Usage |
|---|---|
| Failure Indication | |
| BS Info | |
| BSID | |
| Serving/Target Indicator | |
| MS Info | |
| MSID | |
| Paging Information | |
| Anchor PC ID | |
| Anchor PC relocation destination | |
| Network Exit Indicator | |
| MS Femto Presence Indicator | If Set to 1, it indicates that the MS |
| | is present under a Femtocell |
| | If set to 0, it indicates that the MS |
| | has exited the Femtocell |

At step 808, the paging controller updates database with information associated with the MS. Therefore, on receipt of LU-REQ, the paging controller checks the MS Femto presence indicator field and the paging controller updates it database for the MS accordingly. The updated database also contains an additional field indicating the presence of MS under a femtocell within the paging area. In an embodiment, the database can also contain the femtocell Base Station Identity (BSID) besides the presence indicator. Thereafter, at step 810, the paging controller manages paging of the MS in the paging area based on the updated information in the database

For example, when the page for the MS 108 comes, the paging controller checks its database and if the MS Femto presence indicator field is set, it will page the MS 108 in one or more femtocells in the paging area as indicated by the corresponding Paging Identity (PGID) in the updated database.

Further, if the MS 108 performs LU to the macrocell while exiting a femtocell, the MS Femto presence indicator in the RNG-REQ will be set to 0.

The macrocell BS then forwards the LU-REQ to the ASN-GW which in turn will forward it to the paging controller. The enhanced LU-REQ will contain the MS Femto presence indicator field set to 0. The paging controller on receipt of this LU-REQ with MS Femto presence indicator field set to 0 will match the PGID of the MS in its database. If the PGID received in the LU-REQ is same as in the database then the Paging controller can conclude that the MS still is in the same paging area but it is now not under a femtocell. Hence if a page for the MS arrives, the paging controller can page the MS in one or more macrocells of the paging area.

In second embodiment, when the MS is exiting from a femtocell and entering a macrocell, it will send the RNG-REQ with the MS Femto absence indicator set to 1 to the macrocell. Another reserved bit can be used in the ranging purpose indication field of the RNG-REQ to denote the “The MS Femto absence indicator”. The macrocell on receipt of the RNG-REQ with MS Femto absence indicator set to ‘1’ will send the enhanced LU-REQ to the ASN-GW. The MS Femto presence indicator field in the enhanced LU-REQ will be set to 0. The ASN-GW will in turn forward the request to paging controller.

On receipt of LU-REQ, the paging controller checks the MS Femto presence indicator field and the paging controller updates it database for the MS accordingly. When the page for the MS comes, the paging controller checks its database and as the MS Femto presence indicator field is not set, it will page the MS in one or more macrocells in the paging area as indicated by the PGID in its database.

In yet another embodiment, the indication of entering or exiting the femtocell BS by the MS is avoided. In this embodiment, all the femtocells in the overlaid macro BS are part of the same paging group as the overlaid macro BS. The MS does not indicate to either the femtocell or the macro BS when it enters or exits the femtocell. Thus the paging controller is unaware if the MS is present in the femtocell BS or the macro BS. Here the paging controller uses the multi-step paging in which it first pages the MS in the allowed femtocell BSs only. If there is no response then in the second try the paging controller pages the MS in the entire paging area excluding the femtocell BSs. The second try occurs at the next paging listening period of the MS which occurs after the duration of the paging cycle of the MS.

In this embodiment, further optimization can be done to reduce the paging latency, by paging the MS in the second try earlier than the duration of the paging cycle of the MS. A possible method can be to allocate two different paging offsets to the MS. One method is associated with femtocell BS and the other is associated with macro BS. When the MS is under the femtocell BS, it monitors for its paging on the femtocell specific paging offset. When the MS is under the macro BS it monitors for its paging on the macro BS specific paging offset. The paging offset for the macro BS should occur after the paging offset for the femtocell BS by duration that is sufficient to receive the paging response from the MS.

In yet another embodiment, a paging scheme can be envisaged such that each femtocell is a paging group in itself. It will imply that the MS does a location update when entering or exiting a femtocell. The paging controller will be exactly aware of the femtocell in which the MS is currently under and hence will page it only under that femtocell since the femtocell is a paging area in itself. The scheme will ensure of there are no changes in the paging design as compared to the paging design for the macro BS only.

In yet another embodiment, paging scheme can be envisaged such that a group of femtocells is a paging group in itself. Hence when the MS is under such a paging group, the paging in the macrocells will be avoided. At step 812, the method is terminated.

For the sake of clarity and for the purpose of this description the above methods/embodiments are also explained using following exemplary method in a step by step procedure. The following explained method are just for the sake of clarity and explanation and nowhere limits the scope of the invention.

In one of the method, the following steps are performed.

1) Initially femtocell BSs and overlaid macro BS are part of a same paging group.

2) A MS informs a femtocell BS when it is entering in a femtocell. The MS informs a macrocell BS when it is exiting the femtocell BS and moving to a macrocell BS. For example, this can be achieved by enhancing the existing Location Update procedure in IEEE802.16m.

i. A RNG-REQ message is used to indicate an idle mode location update by appropriate setting of the field ‘ranging purpose indication’ can be enhanced to indicate the MS Femto presence indication of the MS.

ii. The ranging purpose indication field is a bitmap where each bit denotes a specific purpose. For example, in IEEE802.16m system the ranging purpose indication field is an eight (8) bit bitmap, where bit ‘3’ if set indicates idle mode location update. Bits 5, 6 and 7 are reserved. Bit ‘5’ can be used to indicate MS Femto presence indication. This bit in Boolean form can be used to signal both the entry and exit to/from the femtocell.

iii. Another reserved value in the ranging purpose indication field in the RNG-REQ can be used to indicate explicitly about an exit from the femtocell, for example the bit ‘6’ can be used for this purpose. This reserved value can be termed as the MS Femto absence indicator.

3) The femtocell BS or the macrocell BS which receives the RNG-REQ informs the paging controller about the MS entering or exiting a femtocell BS. For example, this can be achieved by enhancing the LU procedure in WiMax forum NWG release R1.2.2.

i. On receipt of the RNG-REQ with MS Femto presence indicator set to ‘1’ in the ranging purpose indication field besides the indication of normal idle mode location update (bit 3), the BS sends the enhanced LU-REQ to the ASN-GW which in turn forwards it to a Paging Controller. The enhanced LU-REQ contains an additional field which is termed as the MS Femto presence indicator. For example, the MS Femto presence indicator field can be one bit information. In this scenario, the MS Femto presence indicator field in the enhanced LU-REQ can be set to 1.

ii. On receipt of LU-REQ, the paging controller checks the MS Femto presence indicator field and the paging controller updates associated database for the MS accordingly. In this scenario, the MS Femto presence indicator field shall be set to ‘1’. In an embodiment, the enhanced database contains an additional field indicating the presence of MS under a femtocell within the corresponding paging area. In another embodiment, the enhanced database can contain the femtocell BSID besides the presence indicator as the femtocell BSID will be contained in the LU-REQ if the MS has performed LU while entering the femtocell.

iii. In the first embodiment, when the MS performs LU to the macrocell while exiting a femtocell, the MS Femto presence indicator in the RNG-REQ will be set to ‘0’. The macrocell BS will set the MS Femto presence indicator field in the enhanced LU-REQ to ‘0’. The macrocell BS then forwards the enhanced LU-REQ to the ASN-GW which in turn will forward it to the paging controller.

iv. In the second embodiment, the macrocell on receipt of the RNG-REQ with MS Femto absence indicator set to ‘1’ shall send the enhanced LU-REQ to the ASN-GW. The MS Femto presence indicator field in the enhanced LU-REQ shall be set to ‘0’. The ASN-GW will in turn forward the request to paging controller.

v. The paging controller on receipt of the LU-REQ with MS Femto presence indicator field set to ‘0’ will match the PGID of the MS in its database. If the PGID received in the LU-REQ is same as in the database then the Paging controller can conclude that the MS still is in the same paging area but it is now not under a femtocell.

4) The femtocell BS keeps a record of all the MSs that are served by it in the idle mode.

5) When the page for the MS arrives at the paging controller, it checks if the MS is in the femtocell BS or not based on MS Femto presence indicator field in its database for the corresponding MS.

6) If the MS is under a femtocell BS, the paging controller pages the MS in one or more femtocell BSs in the paging area as indicated by the PGID for the corresponding MS.

7) If the MS is not under a femtocell BS, the paging controller pages the MS in one or more macrocells in the paging area as indicated by the PGID for the corresponding MS.

8) When the page message arrives at the femtocell BS, it checks with the list of MSs in idle mode currently served by it. If the paged MS ID matches to an entry in the list, it sends the page else it does not send the page.

In another method, the following steps are performed:

1) Femtocell BSs and overlaid Macro BS are part of a same paging group.

2) A MS does not inform either a femtocell BS or a macro BS when it is entering or exiting the femtocell BS.

3) Hence, a paging controller is unaware if the MS is present in the femtocell BS or the macro BS.

4) The paging controller first pages the MS in the allowed femtocell BSs only

5) If there is no response then in the second try the paging controller pages the MS in the entire paging area excluding the femtocell BSs

6) The second try can happen at the next paging listening interval which occurs after the duration of the paging cycle or earlier.

7) If it occurs earlier then one method can be to allocate two different paging offsets to the MS, one for femtocell BSs and the other for macrocell BSs wherein the paging offset for macrocell BSs occurs after the paging offset for the femtocell BSs.

In yet another method, the following steps are performed:

1) Each femtocell or a group of femtocells is a paging area in itself.

2) It will imply that the MS does a location update when entering or exiting a femtocell or a group of femtocells.

3) The paging controller will be exactly aware that the MS is present under one or more femtocells and hence will page it only under those femtocell(s) since those femtocell(s) are a paging area in itself. The illustrated paging schemes can be employed in the upcoming standard of IEEE802.16m. The illustrated paging schemes can as well be adapted for existing 3GPP and IEEE802.16e systems.

Various embodiments of the present invention described above provide the following advantages. The present invention provides a method for managing paging for a communication device in a paging area. The method allows only femtocells in a paging area to page a Mobile Station (MS) when the MS is under a femtocell region. This increases the efficiency of the overall system as it reduces the wastage of costly paging resources. The method can also be easily implemented in the communication technology without affecting the overall cost. The method increases efficiency of the overall communication system.

The method will also reduce paging load in the entire paging area by employing selective paging for the MS, in which case the MS is paged only in the one or more femtocells, if it is present there under a femtocell and the MSs which are not served by the femtocell are not paged in the femtocell by aptly checking the paged MS ID. Hence the costly macrocell paging resources can be avoided.

While the embodiments of the present invention have been illustrated and described, it will be clear that the present invention and its advantages are not limited to these embodiments only. Numerous modifications, changes, variations, substitutions and equivalents will be apparent to those skilled in the art without departing from the spirit and scope of the present invention as described in the claims. Embodiments of the present disclosure are also related to the use of the computer system for implementing the techniques described herein. In one embodiment, the techniques are performed by the processor by using information included in the memory. Such information can be read into the main memory from another machine-readable medium, such as storage device. The information included in the memory causes the processor to perform the method described herein.

The term “machine-readable medium” as used herein refers to any medium of participates in providing data of causes a machine to operation in a specific fashion. In one embodiment is implemented using the computer system, various machine-readable mediums are involved, for example, in providing information to the processor for execution. The machine-readable medium can be a storage media. Storage media includes both non-volatile media and volatile media. Non-volatile media includes, for example, optical or magnetic disks, such as server storage unit. Volatile media includes dynamic memory. All such media must be tangible to enable the information carried by the media to be detected by a physical mechanism of reads the information into a machine.

Common forms of machine-readable medium include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge.

In another embodiment, the machine-readable medium can be a transmission media including coaxial cables, copper wire and fiber optics, including the wires of includes bus. Transmission media can also take the form of acoustic or light waves, such as those generated during radio-wave and infra-red data communications. Examples of machine-readable medium may include, but are not limited to, a carrier wave as or any other medium from a computer can read, for example online software, download links, installation links, and online links.

In the preceding specification, the present disclosure and its advantages have been described with reference to specific embodiments. However, it can be apparent to a person ordinary skilled in the art of various modifications and changes can be made, without departing from the scope of the present disclosure. Accordingly, the specification and figures are to be regarded as illustrative examples of the present disclosure, rather than in restrictive sense. All such possible modifications are intended to be included within the scope of present disclosure.

What is claimed is:

1. A method for managing paging for a communication device in a paging area, the paging area comprising a plurality of base stations and a plurality of communication devices, the method at a second base station comprising:
receiving information associated with a movement of the communication device from a first cell region associated with a first base station to a second cell region associated with the second base station in the paging area, wherein the first base station and the second base station are of different cell types; and
informing a paging controller about the movement of the communication device along with information associated with the communication device when at least one of the first base station and the second base station is a femtocell, wherein the information associated with the communication device is at least one of a Mobile Station Identity (MSID), a Paging area Identity (PGID) and a Base Station Identity (BSID).

2. The method of claim 1, wherein the information associated with the movement of the communication device is received in an Advance Air Interface Ranging-Request (AAI_RNG-REQ) message from the communication device.

3. The method of claim 2, wherein the information associated with the movement of the communication device is received in a ranging purpose indication field of the information AAI_RNG-REQ message.

4. The method of claim 3 further comprising identifying that the communication device is at least one of exiting from a region associated with a femtocell and entering in a region associated with a femtocell based on values of one or more bits in the ranging purpose indication field of the AAI_RNG-REQ message.

5. The method of claim 1, wherein informing the paging controller about the movement of the communication device comprises sending a Location Update (LU)-Request (REQ) message to the paging controller indicating at least one of the movement of the communication device from a femtocell to at least one of a microcell, a macrocell, and a picocell and the movement of the communication device from at least one of a microcell, a macrocell, and a picocell to a femtocell.

6. The method of claim 1, wherein the first base station is at least one of a Macrocell, Microcell, and a Picocell and the second base station is a femtocell.

7. The method of claim 1, wherein the first base station is a femtocell and the second base station is at least one of a Macrocell, Micro cell, and a Picocell.

8. The method of claim 1, wherein the information about the movement of the communication device includes the information about the communication device that is entering in a femtocell region or the information about the communication device that is exiting from a femtocell region.

9. A method for managing paging for a communication device in a paging area, the paging area comprising a plurality of base station and a plurality of communication devices, the method performed at the communication device comprising:
identifying movement of the communication device from a first cell region associated with a first base station to a second cell region associated with a second base station in the paging area, wherein the first base station and the second base station are of different cell types; and
sending information associated with the movement of the communication device from the first cell region to the second cell region to the second base station when at least one of the first base station and the second base station is a femtocell.

10. The method of claim 9, wherein sending information associated with the movement of the communication device comprises sending the information in an Advance Air Interface Ranging-Request (AAI_RNG-REQ) message.

11. The method of claim 10, wherein the information associated with the movement of the communication device is sent in a ranging purpose indication field of the AAI_RNG-REQ message.

12. The method of claim 9, wherein the first base station is at least one of a Macrocell, Microcell, and a Picocell and the second base station is a femtocell.

13. The method of claim 9, wherein the first base station is a femtocell and the second base station is at least one of a Macrocell, Micro cell, and a Picocell.

14. The method of claim 9, wherein the information about the movement of the communication device includes the information about the communication device that is entering in a femtocell region or the information about the communication device that is exiting from a femtocell region.

15. A communication device for managing paging for a communication device in a paging area, the paging area comprising a plurality of base stations and a plurality of communication devices, the communication device comprising:
a processor to identify movement of the communication device from a first cell region associated with a first base station to a second cell region associated with a second base station in a paging area, wherein the first base station and the second base station are of different cell types; and
a transceiver to send information associated with the movement of the communication device from the first cell region to the second cell region to the second base station when at least one of the first base station and the second base station is a femtocell.

16. The communication device of claim 15, wherein sending information associated with the movement of the communication device comprises sending the information in an Advance Air Interface Ranging-Request (AAI_RNG-REQ) message.

17. The communication device of claim 16, wherein the information associated with the movement of the communication device is sent in a ranging purpose indication field of the AAI_RNG-REQ message.

18. The communication device of claim 15, wherein the first base station is at least one of a Macrocell, Microcell, and a Picocell and the second base station is a femtocell.

19. The communication device of claim 15, wherein the first base station is a femtocell and the second base station is at least one of a Macrocell, Micro cell, and a Picocell.

20. The communication device of claim 15, wherein the information about the movement of the communication device includes the information about the communication device that is entering in a femtocell region or the information about the communication device that is exiting from a femtocell region.

21. A paging controller for managing paging for a communication device in a paging area, the paging area comprising a plurality of base stations and a plurality of communication devices, the paging controller comprising:
a transceiver to receive information about a movement of a communication device from a first cell region associated with a first base station to a second cell region associated with a second base station along with information associated with the communication device when at least one of the first base station and the second base station is a femtocell, wherein the first base station and the second base station are of different cell types, further wherein the information associated with the communication device is at least one of a Mobile Station Identity (MSID), a Paging area Identity (PGID) and a Base Station Identity (BSID); and
a memory to maintaining a presence information of the communication device along with the information of the communication device in a database when the communication device is under a femtocell and when at least one of a first cell is a femtocell and a second cell is a femtocell.

22. The paging controller of claim 21, wherein the transceiver receives a page for the communication device from a second communication device for establishing a communication channel, identifies a presence of the communication device in a femtocell based on the presence information of the communication device maintained in the database and pages the communication device in one or more femtocells in the paging area.

23. The paging controller of claim 21, wherein the information about the movement of the communication device is received in a Location Update (LU)-Request (REQ) message indicating at least one of the movement of the communication device from a femtocell to at least one of a microcell, a macrocell, and a picocell and the movement of the communication device from at least one of a microcell, a macrocell, and a picocell to a femtocell.

24. The paging controller of claim 21, wherein the first base station is at least one of a Macrocell, Microcell, and a Picocell and the second base station is a femtocell.

25. The paging controller of claim 21, wherein the first base station is a femtocell and the second base station is at least one of a Macrocell, Micro cell, and a Picocell.

26. The paging controller of claim 21, wherein the information about the movement of the communication device includes the information about the communication device that is entering in a femtocell region or the information about the communication device that is exiting from a femtocell region.
